(19) United States
(12) Patent Application Publication
(10) Pub. No.: US 2012/0229024 A1
(43) Pub. Date: Sep. 13, 2012

(54) Electron source for linear accelerators

(75) Inventor: Terry Arthur Large, West Sussex (GB)

(73) Assignee: Elekta AB (publ), Stockholm (SE)

(21) Appl. No.: 13/045,124

(22) Filed: Mar. 10, 2011

(51) Int. Cl. H05H 9/00; H01J 29/48

(52) U.S. Cl. 315/1; 315/505

(57) ABSTRACT

The present invention provides an electron gun comprising a cathode, for generating electrons; an anode; an intermediate electrode, located between the cathode and the anode; and a controller. The controller applies an electrical potential to said intermediate electrode, analysing a resultant electrical parameter to determine the integrity of said intermediate electrode; and controls the electron gun to emit a pulse of electrons.

### FIELD OF THE INVENTION

The present invention relates to electron sources, and particularly to electron sources for use in linear accelerators and radiotherapy systems.

### BACKGROUND ART

In a triode gun electron source, a grid is placed between the electron source (cathode) and the accelerating electrode (anode) in order to control the flow of electrons out of the electron gun. The general principle of such electron sources is that electrons are liberated from the cathode, and accelerated towards the anode whilst generally also being focussed into a beam. The grid is charged to an electric potential which has a retarding (and therefore controlling) effect on the electrons.

Electron sources have many uses. One such use is in radiotherapy. In this application, the electron source injects electrons into a linear accelerator which accelerates them to relativistic speeds (and therefore therapeutic energies). In one mode of treatment, the electrons themselves are directed towards a target region in a patient. This treatment, known as electron therapy, can be useful in treating targets near or on the surface of the patient. Alternatively the electrons may be directed towards an x-ray target, generating therapeutic x-rays which can be focussed into a beam and directed towards the target region. Radiotherapy systems can be designed to deliver either electron or x-ray radiotherapy, and in fact some systems are capable of selectively delivering both modes of treatment as required (such as that described in PCT application no PCT/GB2009/001217).

Exposure of human or animal tissue to ionising radiation (i.e. electrons, x-rays, etc) will kill the cells thus exposed. In radiotherapy, this principle is used in order to kill specific target cells (e.g. cancerous cells). However, the radiation can also affect neighbouring, healthy tissue and thus significant research is focussed on the goals of minimizing the dose delivered to healthy tissue (for example through shaping and controlling the radiation beam appropriately) and ensuring patient safety during treatment.

Clearly, the electron source is a critical component of any radiotherapy system, and therefore its safety should be considered when assessing the radiotherapy system as a whole.

### SUMMARY OF THE INVENTION

The present inventors have realised that the conventional triode electron gun has a flaw which could result in significant dose of uncontrolled radiation reaching the patient. As described above, a conventional triode electron gun has an electron source (cathode), an accelerating electrode (anode), and an intermediate electrode (grid) positioned between the two. The grid is held at a potential to control the flow of electrons from the cathode to the anode and out of the electron gun.

If the connection to the grid fails (for example, if it becomes open circuit), its voltage will default to the value of the equipotential line between the cathode and the anode. At this voltage, the electron gun is effectively uncontrolled and will deliver full electron flow into the accelerating structure. During electron therapy in particular, this could result in a massive dose to the patient, even from a single pulse of electrons. The dose per pulse could rise by a factor of 300.

Thus, in one aspect of the present invention, there is provided a linear accelerator, comprising an accelerator structure having an electron injection point and defining an electron flow path from said electron injection point; an electron gun, for injecting electrons to the accelerator structure at the electron injection point, comprising: a cathode, for generating electrons; an anode; and an intermediate electrode, located between the cathode and the anode; a source of microwaves, operatively connected to the accelerator structure; and a controller, adapted to: apply an electrical potential to said intermediate electrode, and analyse a resultant electrical parameter to determine whether or not said intermediate electrode is functional; and control the electron gun and the microwave source to emit pulses of electrons and microwaves respectively, timed such that said pulse of electrons is accelerated along the electron flow path.

The resultant electrical parameter may be the current required to charge the intermediate electrode to a particular electric potential. For example, the controller may be adapted to compare the measured current to a threshold and, if the measured current exceeds the threshold, determine that the intermediate electrode is functional.

In an alternative embodiment, the controller is adapted to apply an alternating voltage to said intermediate electrode. In that case, the controller may further measure the ripple current caused by the alternating voltage; compare the ripple current to a threshold; and determine that the intermediate electrode is functional if said ripple current exceeds the threshold.

As will be apparent to those skilled in the art, the anode of the electrode gun may form part of the accelerator structure (i.e. the “anode” is the first accelerating cell of the structure).

The present invention has application in linear accelerators, as noted above. However, the principles set out herein are also application to electron guns more generally. Thus, in a further aspect of the invention there is provided an electron gun comprising a cathode, for generating electrons; an anode; an intermediate electrode, located between the cathode and the anode; and a controller, adapted to: apply an electrical potential to said intermediate electrode, and analyse a resultant electrical parameter to determine the integrity of said intermediate electrode; and control the electron gun to emit a pulse of electrons.

### BRIEF DESCRIPTION OF THE DRAWINGS

An embodiment of the present invention will now be described by way of example, with reference to the accompanying figures in which;

FIG. 1 shows a linear accelerator and electron gun according to embodiments of the present invention; and

FIG. 2 is a flowchart of a method according to embodiments of the present invention.

### DETAILED DESCRIPTION OF THE EMBODIMENTS

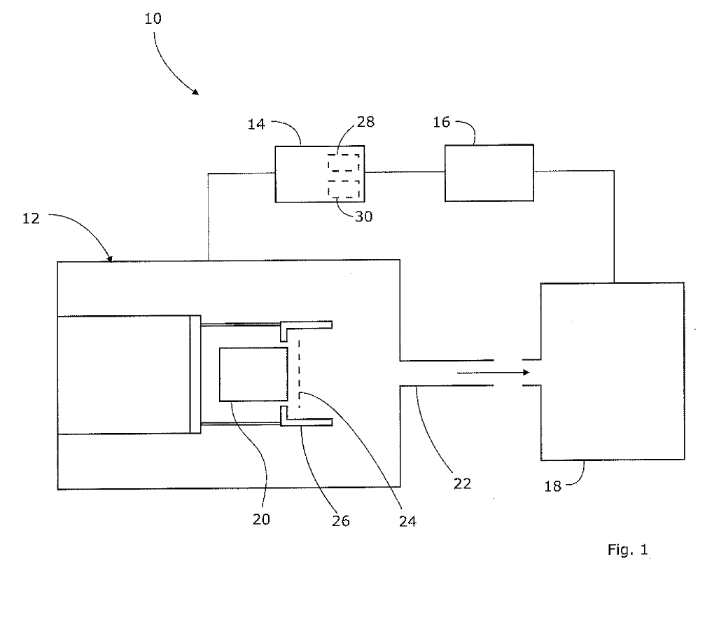

FIG. 1 is a schematic diagram of a linear accelerator (linac) 10 according to embodiments of the present invention. As is conventional in the field, the linac 10 includes a source of electrons 12 (also known as an electron gun), an accelerator structure 18, a source of microwaves 16, and a controller 14 which controls operation of the linac 10 generally, and the sources of electrons and microwaves 12, 16 in particular.

The microwave source 16 may be any device suitable for that purpose, such as a magnetron or a klystron for example. In operation, the controller 14 can control the operation of microwave source 16 to emit pulses or RF power along the accelerator structure 18.

The electron source 12 can be controlled by the controller 14 to inject pulses of electrons to the accelerator structure 18, and in conventional use these are timed to coincide with the microwave pulses. The accelerator structure comprises a plurality of linked accelerating cells (not illustrated), through which is defined an electron flow path. The microwave signal is also transmitted along the accelerator structure, resulting in an electromagnetic standing wave. As the electrons pass through the accelerator structure at relativistic speeds, the timing of microwaves and electrons pulses can be controlled such that the electrons “see” a positive accelerating electric potential in each cell. This will be familiar to those skilled in the art, and is described in more detail in such applications as WO-A-99/40759, WO-A-01/11928 and WO-A-2006/097697.

The electron source 12 has a triode structure. That is, it comprises a cathode 20, which can be heated or cold, from which electrons are liberated. An anode 22 accelerates the electrons towards the accelerator structure 18. In the illustrated embodiment, where the electron source is employed in a linear accelerator 10, the anode 22 may in fact be part of the accelerator structure 18 (for example, the first accelerating cell). Focussing electrodes 26 are positioned around the flow of electrons from the cathode 20, such that the electrons are focussed into a beam suitable for acceleration in the accelerator structure 18.

An intermediate electrode 24, also known as an electron grid, is positioned between the cathode and the anode. In use, this intermediate electrode 24 is generally held at a potential that retards the accelerating motion of the electrons towards the anode. In this way, the flow of electrons out of the electron source 12 to the accelerator structure can be controlled.

The controller 14 comprises at least one voltage source 28 which drives each electrode to its required potential for operation. A number of processes can be used in order to emit a pulse of electrons, as will be known to those skilled in the art. For example, the cathode 20 can be induced to produce free electrons through heating by heating coils or laser pulses (laser not illustrated). Once in such a state, the cathode 20 can be held at a highly negative potential and a negative bias of sufficient voltage applied to the intermediate electrode 24 to hold the electrons in the region of the cathode. The intermediate electrode 24 is then pulsed from its original potential to a less negative potential, resulting in corresponding pulses of electrons being released from the cathode. Alternatively, the cathode 20 itself can be pulsed to a more negative potential.

However, as with all devices, defects can occur in the hardware over time or during manufacture. If such a defect occurs in the connection between the intermediate electrode 24 and its driving voltage source, the electrode becomes open circuit and its potential defaults to the value of the equipotential line between the cathode and anode. In this configuration, the intermediate electrode has no retarding effect whatsoever, and a drastically increased dose of electrons is released from the electron source 12 to the accelerator structure 16 and, potentially, the patient.

According to embodiments of the present invention, the controller 14 comprises means 30 for testing the integrity of the intermediate electrode 24 (i.e. whether it is functional or not), and particularly whether it is correctly connected to its voltage source 28.

In one embodiment, the means 30 checks whether the intermediate electrode 24 is functioning correctly by measuring the current required to charge the intermediate electrode to its required potential and comparing that current to a threshold value. If the current exceeds the threshold (i.e. a relatively large amount of current is required) the intermediate electrode is functioning correctly. If the current is below the threshold (i.e. a relatively small amount of current is required) the intermediate electrode may have become disconnected from the voltage source 28.

In an alternative embodiment, the means 30 checks whether the intermediate electrode 24 is functioning correctly by applying a small alternating voltage (perhaps superimposed on the direct voltage) to the intermediate electrode and measuring the resultant ripple current. If the current exceeds the threshold (i.e. a relatively large value of current is measured) the intermediate electrode is functioning correctly. If the current is below the threshold (i.e. a relatively small amount of current or zero current is measured) the intermediate electrode may have become disconnected from the voltage source 28 because there is no capacitive effect.

In either embodiment, once the fault is detected the electron source 12 and/or the linear accelerator 10 as a whole can be deactivated to ensure the safety of users and patients.

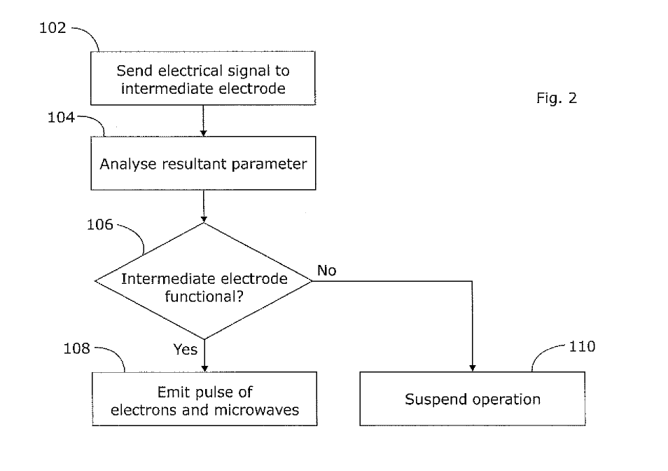

FIG. 2 is a flowchart of a method in accordance with embodiments of the present invention. In step 102, the controller sends an electrical signal to the intermediate electrode to check its integrity. As described above, the electrical signal may be a small alternating voltage, or a direct voltage designed to charge the intermediate electrode 24 to a required potential.

In step 104, a resultant parameter is measured. For example, where a small alternating voltage is applied to the intermediate electrode, a current meter may detect the ripple current. Where a larger, direct voltage is applied to the intermediate electrode, a current meter may detect the current flowing between the voltage source 28 and the intermediate electrode.

In step 106, the measured parameter is compared to a threshold value, and a determination made of whether the intermediate electrode is functioning correctly. For example, where an alternating voltage is applied, if the current exceeds the threshold (i.e. a relatively large value of current is measured) the intermediate electrode is deemed to be functioning correctly. If the current is below the threshold (i.e. a relatively small amount of current or zero current is measured) the intermediate electrode is deemed to have stopped functioning correctly.

Where a larger, direct voltage is applied, if the current exceeds the threshold (i.e. a relatively large amount of current is required) the intermediate electrode is deemed to be functioning correctly. If the current is below the threshold (i.e. a relatively small amount of current is required) the intermediate electrode is deemed to have stopped functioning correctly.

If the intermediate electrode is deemed functional, a pulse of electrons and microwaves can be emitted in step 108 (i.e. operation of the electron source and linear accelerator can continue). If the intermediate electrode is deemed to have stopped functioning, operation is suspended in step 110. For example, the supply of microwaves to the accelerator structure 18 may be suspended so electrons are no longer accelerated to therapeutic energies.

The method according to embodiments of the invention can be performed just prior to operation of the electron source 12, or in between pulses of the electron source 12. In the latter embodiment, the integrity of the intermediate electrode can be checked prior to every pulse, allowing the safety of the linear accelerator to be ensured at all times.

The present invention thus provides an electron source, a linear accelerator and methods of operating both which ensure the continuing safety of the equipment. The electron grid, or intermediate electrode as it has been described here, is checked by applying an electric signal and analysing a resultant electric parameter. If the check reveals the electron grid has become disconnected or otherwise dysfunctional, its operation can be suspended.

It will of course be understood that many variations may be made to the above-described embodiments without departing from the scope of the present invention.

Although the present invention has been described with reference to preferred embodiments, workers skilled in the art will recognize that changes may be made in form and detail without departing from the spirit and scope of the invention.

1. A linear accelerator, comprising:
an accelerator structure having an electron injection point and defining an electron flow path from said electron injection point;
an electron gun, for injecting electrons to the accelerator structure at the electron injection point, comprising:
a cathode, for generating electrons;
an anode; and
an intermediate electrode, located between the cathode and the anode;
a source of microwaves, operatively connected to the accelerator structure; and
a controller, adapted to:
apply an electrical potential to said intermediate electrode, and analyse a resultant electrical parameter to determine whether or not said intermediate electrode is functional; and
control the electron gun and the microwave source to emit pulses of electrons and microwaves respectively, timed such that said pulse of electrons is accelerated along the electron flow path.

2. The linear accelerator according to claim 1, wherein the controller is adapted to measure the current required to charge the intermediate electrode to an electric potential.

3. The linear accelerator according to claim 2, wherein the controller is adapted to compare said measured current to a threshold and, if said measured current exceeds the threshold, determine that said intermediate electrode is functional.

4. The linear accelerator according to claim 1, wherein the controller is adapted to apply an alternating voltage to said intermediate electrode.

5. The linear accelerator according to claim 4, wherein the controller is adapted to:
measure ripple current caused by said alternating voltage;
compare said ripple current to a threshold; and
determine that said intermediate electrode is functional if said ripple current exceeds said threshold.

6. The linear accelerator according to claim 1, wherein the anode is located in the accelerator structure.

7. An electron gun comprising:
a cathode, for generating electrons;
an anode;
an intermediate electrode, located between the cathode and the anode; and
a controller, adapted to:
apply an electrical potential to said intermediate electrode, and analyse a resultant electrical parameter to determine the integrity of said intermediate electrode; and
control the electron gun to emit a pulse of electrons.

8. A method of controlling an electron gun, said electron gun comprising a cathode for generating electrons, an anode, and an intermediate electrode, located between the cathode and the anode, the method comprising:
applying an electrical potential to said intermediate electrode, and analysing a resultant electrical parameter to determine whether or not said intermediate electrode is functional; and
controlling the electron gun to emit a pulse of electrons.

9. The method according to claim 8, further comprising measuring the current required to charge the intermediate electrode to an electric potential.

10. The method according to claim 9, further comprising comparing said measured current to a threshold and, if said measured current exceeds the threshold, determining that said intermediate electrode is functional.

11. The method according to claim 8, further comprising applying an alternating voltage to said intermediate electrode.

12. The method according to claim 11, further comprising:
measuring ripple current caused by said alternating voltage;
comparing said ripple current to a threshold; and
determining that said intermediate electrode is functional if said ripple current exceeds said threshold.

13. A method of operating a linear accelerator, said linear accelerator comprising an accelerator structure having an electron injection point and defining an electron flow path from said electron injection point, an electron gun, for injecting electrons to the accelerator structure at the electron injection point, comprising a cathode, for generating electrons, an anode, and an intermediate electrode, located between the cathode and the anode, and a source of microwaves, operatively connected to the accelerator structure, the method comprising:
applying an electrical potential to said intermediate electrode;
analysing a resultant electrical parameter to determine whether or not said intermediate electrode is functional; and
controlling the electron gun and the microwave source to emit pulses of electrons and microwaves respectively, timed such that said pulse of electrons is accelerated along the electron flow path.
